(19) United States
(12) Patent Application Publication
(10) Pub. No.: US 2004/0082454 A1
(43) Pub. Date: Apr. 29, 2004

(54) Dispenser and sealer for bags

(76) Inventors: Philip L. White, Prospect, CT (US); Donald Barker, Sandy Hook, CT (US); Jeffrey W. Jolie, Deep River, CT (US); Damien Bianchi, Durham, CT (US)

Correspondence Address: PERMAN & GREEN, 425 POST ROAD, FAIRFIELD, CT, 06824, US

(21) Appl. No.: 10/688,667

(22) Filed: Oct. 17, 2003

Related U.S. Application Data
(63) Continuation of application No. 09/889,457, filed on Sep. 28, 2001.
Application No. 09/889,457 is a 371 of international application No. PCT/US00/01230, filed on Jan. 19, 2000.
(60) Provisional application No. 60/116,275, filed on Jan. 19, 1999.

(51) Int. Cl. B31B 49/04

(52) U.S. Cl. 493/189

(57) ABSTRACT

A method and machine for sealing a heat sealable material includes the capability to dispense a desired length of the heat sealable material, automatically select a heating time based on one or more sealing parameters, and apply heat to a portion of the heat sealable material according to a sealing routine that utilizes the automatically selected heating time.

This application is a continuation of application Ser. No. 09/889,457, filed Jul. 16, 2001.

### BACKGROUND

1. Field

The present exemplary embodiments relate to bags generally and, more particularly to a dispenser and sealer for bags.

2. Brief Description of Related Developments

Sealable bags are widely used for the storage of materials. The materials can range from foodstuffs to small parts. There is known manually operated sealing equipment for home use for the storage of foodstuffs and also manually operated sealing machines used, for example, for forming bags to contain small parts to be sold in the bags. In both cases, one selects a bag of desired length, the bag having one end sealed and one end open, places the foodstuffs or small parts or etc. into the bag, and then places the open end of the bag into a sealer to form a sealed bag containing the materials, One problem with such manual sealing devices is that the seals are often not neat and consistent in appearance, one must in some cases guess as to how long to apply the seal, and the seals may not be parallel to the ends of the bag.

In some cases, the user of the bags must inventory a number of bags of different lengths, resulting in unnecessary cost and the possibility of confusion and waste resulting from selecting a bag of the wrong length.

Also known are industrial machines for producing sealed bags from a roll of tubular material. These machines are typically large and heavy and are used principally to form bags of a given length in long production runs. The length of the bags produced can usually be changed; however, such changing is time consuming and is not practical for frequent changing of bag lengths produced.

A problem common with conventional machines that cut the bag material is that the machines employ hot wire cutters that produce undesirable smoke and odor.

A problem common with conventional automatic heat sealing machines is that the heat sealing element is difficult to replace when it burns out.

What is desirable is to have a bag producing machine that is compact and operator controllable to produce bags of different lengths and widths without complicated and time-consuming machine revisions.

### SUMMARY OF THE EXEMPLARY EMBODIMENTS

A first exemplary embodiment provides an apparatus and method for automatically controlling sealing operations while accounting for various factors that may influence the sealing operation, for example, material thickness, the temperature of a heater bar, and the number of seals that have been made. The present exemplary embodiment includes one or more heater bar algorithms that may automatically determine a heating time based on one or more factors, for example, a present heater bar temperature, a minimum heating time based on the present heater bar temperature, a heating time for a first group of sealing operations, and a heating time for a subsequent group of sealing operations. The heater bar algorithms may also perform bounds checking and adjustments to yield a finally determined heating time which may then be used to control the application of power to form a seal.

Another exemplary embodiment provides a method and machine for sealing a heat sealable material that includes the capability to dispense a desired length of the heat sealable material, automatically select a heating time based on one or more sealing parameters, and apply heat to a portion of the heat sealable material according to a sealing routine that utilizes the automatically selected heating time.

### BRIEF DESCRIPTION OF THE DRAWINGS

The foregoing aspects and other features of the exemplary embodiments are explained in the following description, taken in connection with the accompanying drawings, wherein:

FIG. 1 is a perspective view of a dispenser and sealer for sealable bags, with one roll of tubular sealable material mounted therein;

FIG. 2 is a perspective view of the dispenser and sealer for sealable bags, with two rolls of tubular sealable material mounted therein;

FIG. 3 is a top plan view, partially cut-away and partially in cross-section, of the major internal elements of the dispenser and sealer for sealable bags;

FIG. 4 is a side elevational view, partially cut-away and partially in cross-section, of the major internal elements of the dispenser and sealer for sealable bags;

FIG. 5 is a side elevational view of the cutter and heater assemblies for the dispenser and sealer for sealable bags;

FIG. 6 is a fragmentary side elevational view of the cutter and lower knife assemblies for the dispenser and sealer for sealable bags;

FIG. 7 is a front elevational view of the upper knife for the dispenser and sealer for sealable bags;

FIG. 8 is a front elevational view, partially cut-away and partially in cross-section, of a dual element heater bar block of the dispenser and sealer for sealable bags;

FIG. 9 is a block diagram of a control system for use in the dispenser and sealer for sealable bags;

FIG. 10 shows another embodiment of a dispenser assembly;

FIG. 11 shows another embodiment of a control system for use in the dispenser and sealer for sealable bags; and

FIG. 12 is a block diagram of a control system of the dispenser in accordance with another embodiment of the invention; and

FIGS. 13 through 20 show flow charts of the operation of a heater bar algorithm for controlling the dispenser and sealer for sealable bags.

### DETAILED DESCRIPTION OF THE EXEMPLARY EMBODIMENT(S)

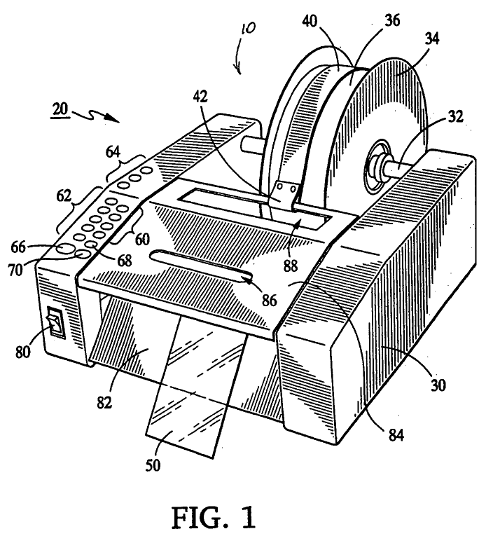

Referring to FIG. 1, a system 10 incorporating features of the exemplary embodiments is illustrated. Although the exemplary embodiments will be described with reference to the embodiments shown in the drawings, it should be understood that there may be many alternate forms of the exemplary embodiments. In addition, any suitable size, shape or type of elements or materials could be used.

Reference should now be made to the drawing figures, on which similar or identical elements are given consistent identifying numerals throughout the various figures thereof, and on which parenthetical references to figure numbers direct the reader to the view(s) on which the element(s) being described is (are) best seen, although the element(s) may be seen also on other views.

FIG. 1 illustrates a dispenser and sealer for heat sealable bags, the machine being constructed according to the exemplary embodiments, and indicated generally by the reference numeral 20.

Machine 20 includes a housing 30 in which is mounted a horizontal feed roll shaft 32 on which shaft is rotatably mounted a supply roll 34 containing a continuous tubular heat sealable material 36. A flexible drag strap 40 has its proximal end 42 rotatably attached to a portion of housing 30 and is disposed over material 36 with a weight (not shown on FIG. 1) attached to the distal end of the strap such that the strap acts, as a drag to prevent undesirable rotation of supply roll 34.

As is described more fully below, machine 20 is provided to automatically dispense a bag 50 of selected length from supply roll 34 and heat seal one end of the bag. Bag 50 can then be manually removed from machine 20, small parts, for example, placed in the bag through the open end thereof, and then the open end of the bag is reinserted in the machine to heat seal the open end.

Machine 20 includes a plurality of pushbuttons 60 with which to enter the thickness of heat sealable material 36, the thickness setting serving as an input to the heat sealing control, a thicker material requiring a longer heat sealing time than a thinner material. Machine 20 may also include a plurality of pushbuttons 62 with which to select the length of bag 50, a plurality of pushbuttons 64 with which to select the roll from which bag 50 is to be dispensed when more than one roll is provided, a START pushbutton 66 with which to initiate the dispensing and sealing operation, a FEED pushbutton 68 that dispenses bag 50 as long as that pushbutton is depressed, and a SEAL pushbutton 70 that initiates a sealing process. Completing the major elements of machine 20 visible on FIG. 1, there are provided a power switch 80, a lower guide 82, a removable or hinged cover 84, and two openings 86 and 88 defined through the cover to view operation of the machine.

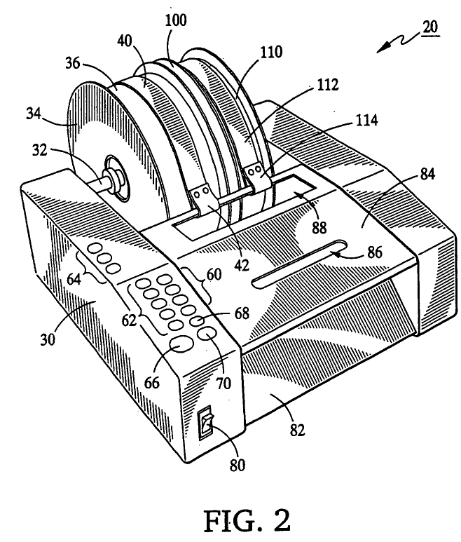

FIG. 2 illustrates machine 20 and the same elements as shown and described with reference to FIG. 1, except in this case a second supply roll 100 is rotatably mounted on supply roll shaft 32 and contains a continuous tubular heat sealable material 110 having disposed thereon a flexible drag strap 112, similar in form and function to drag strap 40, with the proximal end 114 of strap 112 being rotatably attached to a portion of housing 30. It will be noted that material 36 is wider than material 110 so that a bag may be dispensed having a selected one of two different widths. Any number of supply rolls may be mounted on feed roll shaft 32 within the limits of machine 20.

Pushbuttons 64 are used to select from which supply rolls 34 or 100 heat sealable bags will be dispensed and can be used to control any suitable electromechanical means to select from which roll to dispense heat sealable material, such as an electromechanical clutch/release mechanism (not shown) cooperating with feed roll shaft 32.

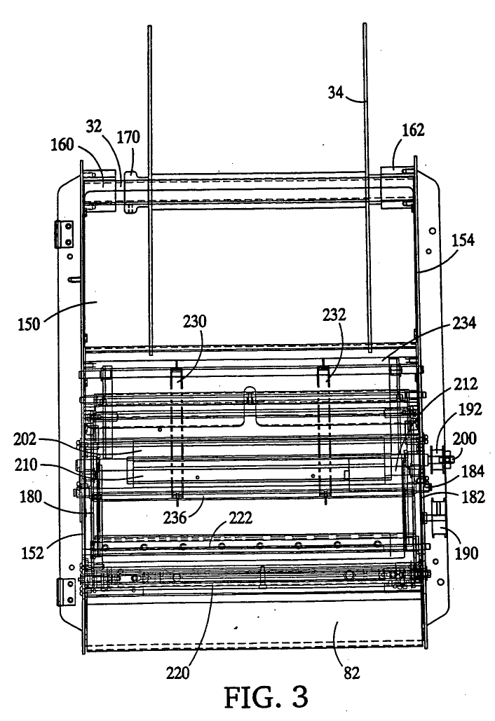

Reference should now be made to FIG. 3 for a general understanding of the arrangement of the major internal elements of machine 20 (FIG. 1) shown on FIG. 3 in their non-dispensing positions. The major internal elements of machine 20 include a generally planar, horizontal base plate 150 with first and second, generally planar, vertical side plates 152 and 154, respectively, fixedly attached thereto. First and second side plates 152 and 154 are disposed inwardly of the vertical sides of housing 30 of machine 20 (FIG. 1). Feed roll shaft 32 is rotatably journaled in upwardly open, U-shaped, first and second bearing members 160 and 162, respectively, fixed to first and second side plates 152 and 154. Supply roll 34 is shown on feed roll shaft 32 and is held in place by means of a releasable clamp 170.

First and second pivot arm assemblies 180 and 182 are pivotally mounted, respectively, to first and second side plates 152 and 154 by means of a horizontal pivot arm assembly shaft 184 extending between the first and second side plates.

A bag drive motor output pulley 190 and a bag drive roller pulley 192 extend outwardly of second side plate 154, the bag drive motor output pulley driving the bag drive roller pulley by means of a continuous belt (not shown on FIG. 3) extending therebetween. Bag drive roller pulley is fixedly mounted on bag drive roller shaft 200 that extends between first and second side plates 152 and 154 and rotation of the bag drive roller shaft causes a bag drive roller 202 fixedly mounted on bag drive roller shaft 200 to rotate. A bag pinch roller 210 is mounted generally above bag drive roller 202 on a bag drive roller shaft 212 and has its ends rotatably mounted in first and second pivot arm assemblies 180 and 182.

A heater assembly 220 is disposed horizontally between first and second side plates 152 and 154 near the inboard edge of lower guide 82, while a horizontal cutting assembly 222 is disposed inwardly of the heater assembly and extends between and is rotatably attached to first and second pivot arm assemblies 180 and 182. First and second pivot arm assembly springs 230 and 232 extend between a horizontal spring shaft 234 fixedly attached to and extending between first and second side plates 152 and 154 and a spring return shaft 236 fixedly attached to and extending between a forward portion of first and second pivot arm assemblies 180 and 182.

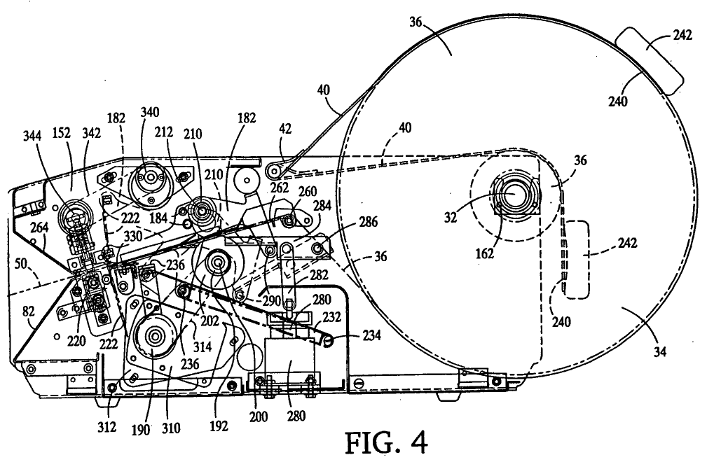

FIG. 4 illustrates the internal elements of machine 20 (FIG. 1) as if second side plate 182 had been removed. It will be understood that, while second pivot arm assembly 182 is shown on FIG. 4, an identical first pivot arm assembly 180 is positioned behind the second pivot arm assembly. Second pivot arm assembly 182 is shown in solid lines in its non-dispensing, or cutting, position and is shown in broken lines in its dispensing position in which material 36 may be dispensed by machine 20 to form bag 50.

First, it can be seen that distal end 240 of drag strap 40 has fixedly attached thereto a weight 242 and that the drag strap continues to engage material 36 as the roll of material is diminished in diameter. This arrangement is simple and keeps a fairly even drag pressure on roll of material 36.

Material 36 feeds from the bottom of supply roll. 34 while pulling the supply roll in a clockwise direction as seen on FIG. 4. Material 36 then passes over an idler roller 260 disposed between first and second side plates 152 and 154, along a plate 262 fixedly attached to the first and second side plates, past cutter assembly 222, through heater assembly 220, and exiting machine 20 between lower guide 82 and upper guide 264 to become heat sealable bag 50. Operation of machine 20 (FIG. 1) is initiated, after selection of length and thickness (and roll, if more than one roll is provided) by depressing START pushbutton 66. This starts the following procedure. The motive power for moving material 36 along the path described above is provided by supplying electrical power to a suitable actuator such as a solenoid 280, centered between first and second side pivot arm assemblies 180 and 182, drawing a solenoid core 282 downwardly and, likewise, drawing downwardly a first link 284 rotatingly attached at its lower end to the distal end of the solenoid core. The upper end of first link 282 is rotatingly attached to a second link 284 and the latter motion causes this second link to rotate counterclockwise, as seen on FIG. 4, about a shaft 286 fixedly disposed between first and second side plates 152 and 154. This motion draws downwardly a rod 290 fixedly disposed between first and second pivot arm assemblies 180 and 182 and engaging a lower surface of second link 284, thus causing the first and second pivot arm assemblies to rotate clockwise, as seen on FIG. 4, about pivot arm assembly shaft 184 to the position shown in broken lines. The pivoting of first and second pivot arm assemblies 180 and 182 raises cutter assembly 222, fixedly attached to the first and second pivot arm assemblies, to permit material 36 to pass thereunder and lowers bag pinch roller 210 to create a nip between the bag pinch roller and bag drive roller 202. Now, when drive motor output pulley 190 is rotated counterclockwise by a motor associated with gear box 310 mounted on adjustment plate 312, continuous belt 314 will cause bag drive roller pulley 192 and bag drive roller to rotate counterclockwise, drawing material 36 to the left as seen on FIG. 4. In alternate embodiments, the cutter assembly 222 may be actuated between lowered and raised positions by any suitable drive system including, for example, a drive system powered by a motor.

When the desired length of bag 50 has been dispensed, drive motor output pulley 190 ceases rotating and power is removed from solenoid 280. The latter causes first and second pivot arm assembly springs 230 and 232 to rotate first and second pivot arm assemblies 180 and 182 counterclockwise, as seen on FIG. 4, about pivot arm assembly shaft 184, lowering cutter assembly 222 which causes the cutter assembly to slide against lower knife assembly 330, thus shearing material 36. In the case where the cutter is actuated by a motor drive system power is maintained to the cutter drive to lower the cutter assembly against the lower knife assembly.

Before material 36 is cut to the desired length, electrical power applied to heater seal bar drive 340 causes a continuous belt 342 to rotate a first cam assembly 344 which initiates the bag sealing operation described below.

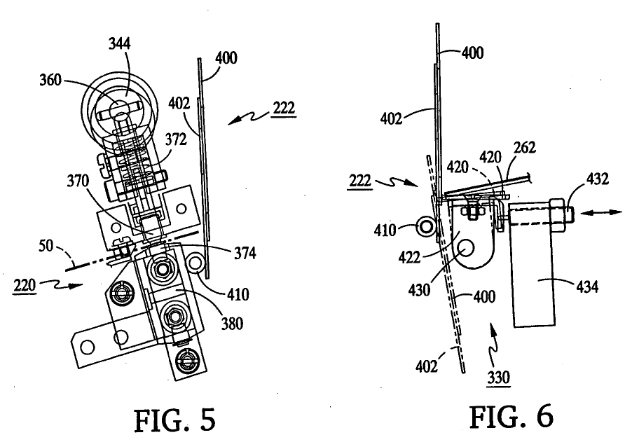

FIG. 5 illustrates heater assembly 220. Heater assembly 220 includes first cam assembly 344 that is fixedly mounted on a cam assembly shaft 360 rotatingly attached to and extending between first and second side plates 152 and 154. Cam assembly 344 is adjacent first side plate 152 and a second, similar cam assembly is disposed adjacent second side plate 154. Cam assembly 344 is provided to drive downwardly an elongated, horizontal heater seal bar 370, biased upwardly by a spring 372, to press an end of bag 50 against a heater bar 374. Heater bar 374 has its upper surface covered with a patterned Teflon tape to impart a complementarily shaped pattern to the sealed area of bag 50 so that it does not fall out of machine 20 after the sealing and cutting operation. The Teflon tape also protects heater bar 374. Heater bar 374 is disposed in a heater bar block 380 the details of which are described below.

As is indicated above, heat is applied for a time sufficient to seal bag 50, the time depending on the thickness of material 36, with thicker materials having a longer sealing time than thinner materials. After heat is applied, heater seal bar 370 is left in place against the upper surface of the sealed area of bag 50 for a brief period of time to permit a degree of cooling. After the cooling period, heater seal bar 370 is raised and bag 50 can be manually removed from machine 20. Then, for example, parts can be placed in bag 50, the open end of the bag is inserted in machine 20 between upper exit guide 264 and lower exit guide 82, with the upper end of the bag against cutter assembly 222 which is in its lowered position when material 36 is not being dispensed, and SEAL pushbutton 70 (FIG. 1) is depressed to start the sealing operation to seal the open end. Alternatively, a foot switch (not shown on FIG. 5) may initiate the second sealing step to as to leave free the hands of the operator. Having a stop for the open end of bag 50, in this case cutter assembly 222, assures that the second seal is parallel with the ends of the bags. The “stop” is approximately one-half-inch from the portion of the bag to be sealed. Re-insertion of bag 50 in machine 20 is facilitated by upper and lower guides 264 and 82.

FIG. 5 also illustrates cutter assembly 222. Cutter assembly 222 includes a generally vertical upper knife 400 to which is fixedly attached an upper knife guide 402. Upper knife guide 402 is narrow and is disposed at the end of upper knife 400 adjacent first side plate 152. The outer surface of upper knife guide 402 rides on a roller 410 that is rotatingly attached to first side plate 152 to guide cutter assembly 222 as it moves up and down.

FIG. 6 illustrates cutter assembly 222 and lower knife assembly 330 and shows the function of roller 410 as cutter assembly 222 is moved from its dispensing, raised position (solid lines) to its lowered position (broken lines) after having cut material 36 (not shown on FIG. 6). Since cutter assembly 222 is fixedly attached to first and second pivot arm assemblies 180 and 182, the cutter assembly rotates as the pivot arm assemblies rotate. Cutting of material 36 is effected by the lower edge of upper knife 400 sliding against the forward edge of a lower knife 420 fixedly mounted on lower knife mounting block 422 and extending along the upper knife. Mounting block 422 is pivotally mounted on a shaft 430 extending between first and second side plates 152 and 154 and is biased forwardly, that is toward upper knife 400, by means of a spring-loaded plunger 432 disposed for axial movement in a plunger mounting block 434 fixedly attached to first side plate 152.

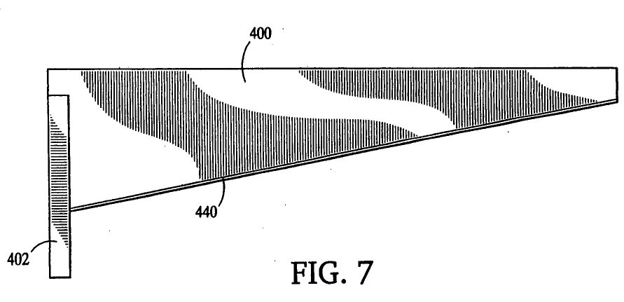

FIG. 7 illustrates upper knife 400 and shows that cutting edge 440 thereof tapers upwardly from the end of the upper knife adjacent first pivot arm assembly 180 to the end of the upper knife adjacent second pivot arm assembly 182. FIG. 7 also shows more clearly upper knife guide 402 fixedly attached to the front surface of upper knife 400.

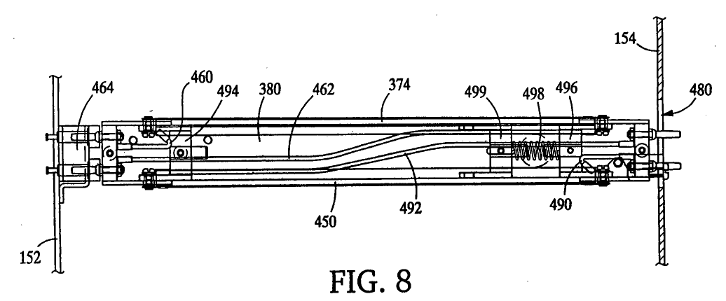

FIG. 8 illustrates heater bar block 380 and shows that the heater bar block has heater bar 374 disposed along the upper surface thereof and has an identical spare heater bar 450 disposed along the lower surface thereof. The exemplary embodiments address the problem of difficulty in replacing burned out heater bars by providing heater bar block 380 having dual elements. Electrical power is furnished to heater bar 374 through wires 460 and 462 operatively connected to a receptacle block 464 fixedly mounted on first side plate 152. When heater bar 374 burns out, mounting screws 470 and 472 are removed and heater bar block 380 is unplugged from receptacle block 464 by withdrawing the heater bar block through an opening 480 defined through second side plate 154. Heater bar block 380 is then rotated 180 degrees with respect to its major axis, rotated end for end, reinserted into opening 480, replugged into receptacle block 464, and mounting screws 470 and 472 are reattached. Heater bar 450 is now on the upper surface of heater bar block 380 and is supplied electrical power through wires 490 and 492.

As seen on FIG. 8, heater bars 374 and 450 are supported by, and attached to, at the left ends thereof a fixed support block 494 and are supported by, and attached to, at the rights ends thereof a sliding support block 496. To accommodate expansion and contraction of heater bars 374 and 450 as they heat and cool, a biasing spring 498 is provided between sliding support block 496 and a fixed block 499 to maintain tension on the heater bars.

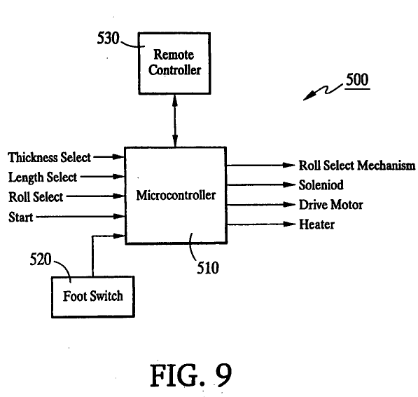

FIG. 9 illustrates a control system for machine 20 (FIG. 1), the control system being generally indicated by the reference numeral 500. Control system 500 includes a controller 510 that is desirably located in housing 30. Controller 510 receives inputs of selected material thickness, selected bag length, selected supply roll, START, and an input from a foot switch 520 that may be provided to initiate bag dispensing and/or for providing a signal to initiate sealing of the open end of the bag. The selection inputs may be provided by means of depressing selected ones of pushbuttons 60, 62, 64, 66, and 70 (FIG. 1). Controller 510 provides outputs to the roll selection mechanism, the solenoid, the drive motor, and the heater. A remote controller or computer or the like 530 may be provided operatively connected to controller 510 to control certain functions of machine 20 and/or to monitor operation of machine 20.

Machine 20 offers a number of advantages over conventional means for forming bags of varying lengths and widths. First, machine 20 is of “table-top size,” is relatively light, and is very portable. Housing 30 is on the order of the size of a conventional typewriter and machine 20 weighs less than about 50 pounds,

Cutting with a knife eliminates the hot wire typically used to cut bag material, the hot wire generating undesirable smoke and odor.

The operator is in control of the length (and width, if desired) of each bag individually, since the length and width can be chosen for each bag. If material on different rolls have different thicknesses, thickness can also be a chosen parameter.

Machine 20 produces bags with neat and consistent seals, parallel to the ends of the bags. Pre-selection of heating time facilitates uniform sealing.

Any heat sealable material can be used with machine 20. The material may be clear, opaque, colored, preprinted, anti-static, or any combination of these, for example. Printing may be placed on the bags as they are dispensed.

The heating element in machine 20 can be easily and quickly replaced.

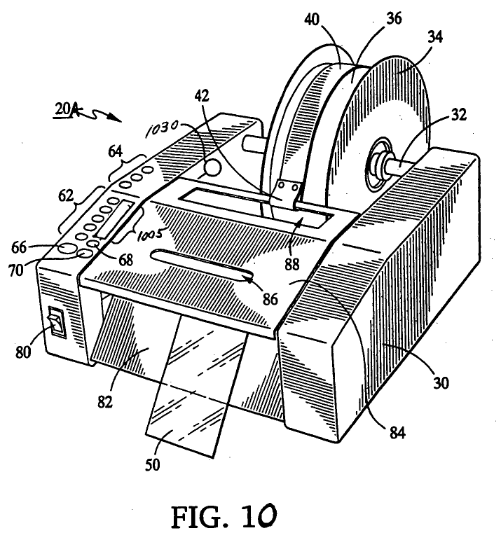

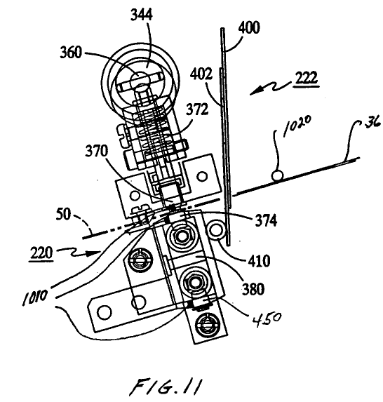

FIG. 10 shows another embodiment similar to machine 20 shown as machine 20A. Material thickness, width, a roll selection or any combination of these items may be entered using a control 1005 as part of machine 20A. Control 1005 may be a selector, a dial, a potentiometer, or any other device that is capable of producing a signal signifying the appropriate parameter or selection. Control 1005 may be similar to or included in the plurality of pushbuttons 64 and may be operable to select one or more supply rolls, for example rolls 34, 100 (FIG. 2) from which material 36, 110 may be dispensed. Control 1005 may also provide an indication of material thickness, width, a roll selection or any combination of these items to a processor and to one or more algorithms as described in detail below. Control 1005 may also include a display for presenting the material thickness, width, a roll selection or any combination of these items to a user.

This embodiment of machine 20A may also include an ambient temperature sensor 1030 for determining the temperature of the environment of machine 20A. Ambient temperature sensor 1030 may be a thermistor, thermocouple, a resistance temperature device (RTD), an infrared sensor or any other suitable temperature sensing device and may also include any support circuitry required for operation. Ambient temperature sensor 1010 may be capable of measuring any environmental temperature and may provide an analog or digital output. Ambient temperature sensor 1030 may be a single temperature sensor integral to, located proximate to, or located in the vicinity of, machine 20A, or may include a plurality of sensors, integral to, or positioned proximate machine 20A. Alternately, ambient temperature sensor 1030 may be any number of sensors placed at any location so long as the temperature of the environment of machine 20A may be measured.

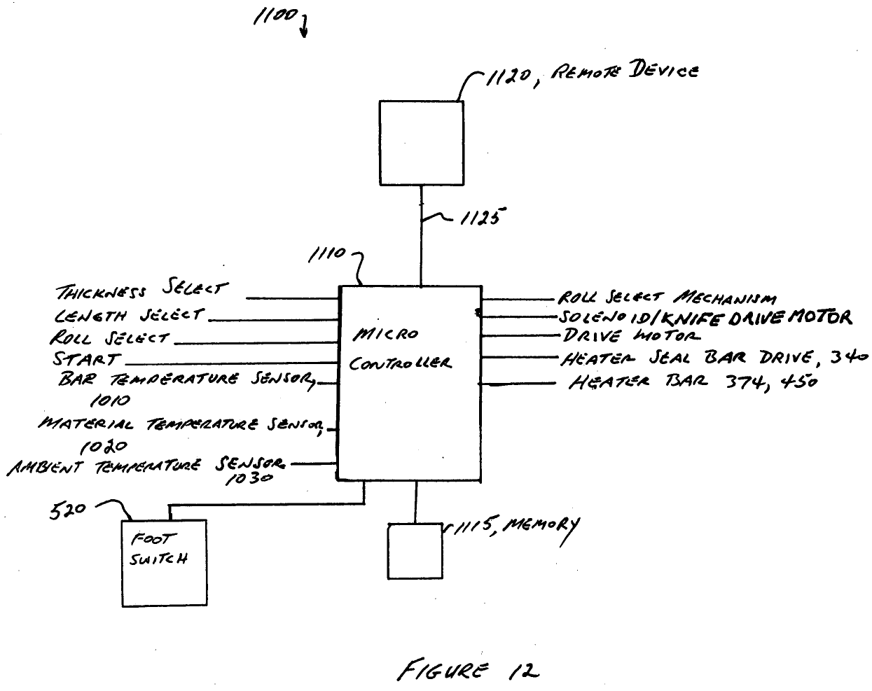

FIG. 11 shows another embodiment of a heater assembly 220A similar to heater assembly 220 (FIG. 5). In addition to the features of the embodiment of the heater assembly 220 shown in FIG. 5, this embodiment includes a bar temperature sensor 1010 for determining the temperature of heater bars 374, 450. Bar temperature sensor 1010 may be a thermistor, thermocouple, a resistance temperature device (RTD), an infrared sensor or any other suitable temperature sensing device and may also include any support circuitry required for operation. Bar temperature sensor 1010 may be capable of measuring any temperature that may be present on heater bars 374, 450, and may provide an analog or digital output. Bar temperature sensor 1010 may be a single temperature sensor integral to, located proximate to, or located in the vicinity of, heater bar 374 or heater bar 450 whichever is in use, or may include a plurality of sensors, integral to, or positioned proximate to each heater bar 374, 450. Alternately, bar temperature sensor 1010 may be part of heater seal bar 370, or located proximate heater seal bar 370. In another embodiment, bar temperature sensor 1010 may be any number of sensors placed at any location so long as the temperature of heater bars 374, 450 may be discerned. For purposes of the exemplary embodiments disclosed herein, the heater bar 374, 450 to which power is being applied is referred to as the active heater bar 374, 450.

A material temperature sensor 1020 may also be included for determining the temperature of heat sealable material 36. Material temperature sensor 1020 may be similar to bar temperature sensor 1010, and may be a thermistor, thermocouple, a resistance temperature device (RTD), an infrared sensor or any other suitable device for sensing the temperature of heat sealable material 36. Material temperature sensor 1020 may also include additional support circuitry required for operation. Material temperature sensor 1020 may be capable of measuring the full range of temperature that material 36 may obtain and may provide an analog or digital output. Material temperature sensor 1020 may be a single temperature sensor or a group of sensors, and may be integral to, located proximate to, or located in the vicinity of, material 36. Alternately, material temperature sensor 1020 may be located anywhere within machine 20A so long as the temperature of material 36 may be perceived.

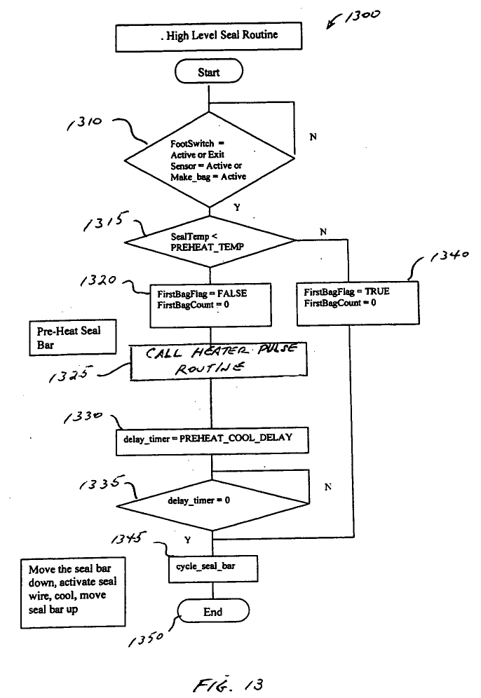

FIG. 12 shows another embodiment of a control system 1100 for controlling the operation of machine 20A. Control system 1100 includes a controller 1110 which may receive inputs of selected material thickness, selected bag length, selected supply roll, START, and an input from foot switch 520 for controlling machine operations. The selection inputs may be provided by means of depressing selected ones of pushbuttons 60, 62, 64, 66, and 70 (FIG. 1), or from control 1005 (FIG. 10).

In addition, controller 1110 may be connected to bar temperature sensor 1010 (FIG. 11), material sensor 1020 (FIG. 11), and ambient temperature sensor 1030 (FIG. 10) and may receive information about the temperature of heater bars 374, 450, heat sealable material 36, and the ambient temperature of the environment in which machine 20A is operating. Controller 1110 may also provide outputs to the roll selection mechanism, the drive motor, the heater seal bar drive 340 (FIG. 4), the solenoid 280 (FIG. 4), and the active heater bar 374, 450 (FIG. 11). As such, controller 1110 may have an internal timing capability to provide pulses of varying periods and duty cycles for controlling the active heater bar 374, 450. Controller 1110 may be capable of counting the number of times heater seal bar drive 340, solenoid 280, or active heater bar 374, 450, may have been activated to determine a number of bags created or a number of seals produced during a particular period of time. Other devices or techniques may also be used to effectively count the number of bags or seals. Controller 1110 may also controllably interface, by any suitable communication means, to a downstream process device (not shown). The downstream process device may be any suitable device for handling the bags dispensed from machine 20A.

A remote control, terminal, or computer, referred to as a remote device 1120, may be connected to controller 1010 through a link 1125. Link 1125 may be a direct connection, in the form of a wired, wireless, optical, infrared, or any other suitable type of direct connection. Link 1125 may also include any suitable communications network, for example, the Public Switched Telephone Network (PSTN), a wireless network, a wired network, a Local Area Network (LAN), a Wide Area Network (WAN), virtual private network (VPN) etc. Remote device 1020 may communicate bi-directionally over link 1125 using any suitable protocol, or modulation standard, for example, X.25, ATM, TCP/IP, V34, V90, RS-232 etc.

Control system 1110 may also include a memory 1115. Memory 1115 may generally hold programs and instructions for controller 1110 including an operating system, look up tables, control parameters, etc. In particular, memory 1115 may store the number of times heater seal bar drive 340, solenoid 280, or active heater bar 374, 450, may have been activated, to be used by controller 11110 to determine a number of bags created or a number of seals produced during a particular period of time. In addition, memory 1115 may include one or more algorithms for use by controller 1110 in controlling heater bars 374, 450. Memory 1115 may also be capable of storing values utilized by or calculated by the one or more algorithms. The total number of bags made and a resetable bag count values are kept in the memory 1115.

At least one algorithm for controlling heater bars 374, 450, referred to herein as a heater bar algorithm, may account for various factors that may influence the sealing operation. For example, the ambient temperature may be considered in that heater bars 374, 450 may have to be controlled in a different manner when machine 20A is located in a relatively cold environment, for example, 15 degrees C., as opposed to a relatively hot environment, for example, 37 degrees C.

The temperature of heater bars 374, 450 may also be taken into consideration as variations in material 36, the amount of use, the time heater bars 374, 450 have been energized, and other factors may affect heater bar temperature. For example, relatively short thick material may cause heater bars 374, 450 to increase in temperature faster than relatively long thin material. This may at least in part be due to longer sealing duration and a higher frequency of sealing cycles.

The temperature of heat sealable material 36 may also be considered in that heater bars 374, 450 may have to be controlled in a different manner when heat sealable material 36 is relatively cold as opposed to being relatively hot. Heat sealable material 36 having a colder temperature may require more sealing energy than material that has a higher temperature.

The thickness of heat sealable material 36 may be also be considered in that thicker material may require more energy to produce an adequate seal. Typical material thickness may be in the range of about 1.5 mils to 10 mils.

The material width may also be considered because a wider material generally tends to insulate heater bars 374, 450, holding in the heat and causing an elevated heater bar temperature. Typical material width may be in the range of about 1-8 inches.

Furthermore, heater bars 374, 450 may be controlled in a different manner if the seal being made is the first of a particular batch.

The heater bar algorithm may include several components, for example: a high level seal routine that provides for overall sealing operation; a cycle seal bar routine that controls lowering heater seal bar 370, initiates a heater pulse routine, and controls raising heater seal bar 370; a heater pulse routine for controlling the amount of power applied to the active heater bar 374, 450; and, a subroutine which may be called by the heater pulse routine for calculating a heat time. Each of these components will be described in detail below. The following parameters, referred to as seal parameters, may be utilized by the heater bar algorithm:

MINSEALTEMP: The active heater bar temperature above which the seal time starts to decrease;

MAXSEALTEMP: The active heater bar temperature above which the seal time stops decreasing;

MINHEATTIME: The heating time (heat_time) for an active heater bar temperature that is less than or equal to MINSEALTEMP;

MAXHEATTIME: The heat_time for a particular active heater bar temperature that is greater than or equal to MAXSEALTEMP;

FBMINHEATTIME: The heat_time used for the first bag for an active heater bar temperature that is less than MINSEALTEMP; and

FBMAXHEATTIME: The heat_time used for the first bag for a an active heater bar temperature that is greater than MAXSEALTEMP.

For purposes of the exemplary embodiments disclosed herein, the heating time, also referred to as heat_time, refers to the amount of time power is applied to active heater bar 374, 450 when it is in contact with heat sealable material 36.

The heater bar algorithm may utilize a number of constants, for example:

PREHEAT_TEMP: The PREHEAT_TEMP is the temperature below which an active heater bar pre-heat cycle will be performed. In one embodiment, the PREHEAT_TEMP may be, for example, approximately 33 degrees C.;

PREHEAT_COOL_DELAY: The time the active heater bar 374, 450 is allowed to equilibrate after a preheat cycle. In one embodiment, the PREHEAT_COOL_DELAY may be, for example, approximately 2500 mSeconds;

SEAL_DWELL_DELAY: The time active heater bar 374, 450 may be held in the down position, to allow cooling after the seal is complete. In one embodiment, the SEAL_DWELL_DELAY may be for example, approximately 400 mSeconds;

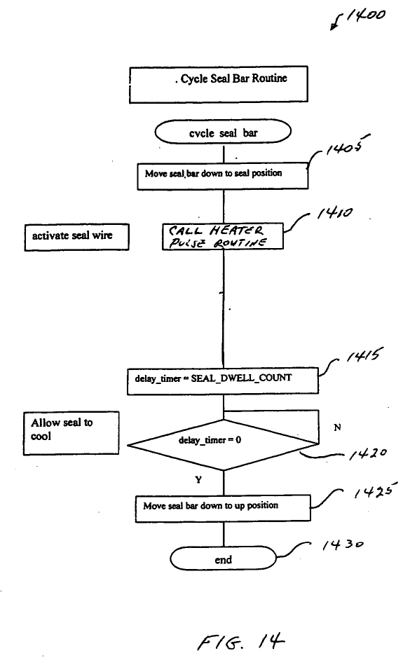

An example of the operation of the heater bar algorithm may be described in detail with reference to FIGS. 13 through 20.

FIG. 13 shows a flow diagram of an example of the high level seal routine 1300. In step 1310, initiation of high level seal routine 1300 may begin for example when a user selects a bag length and presses the START pushbutton 66 or selects the bag length via the remote device 1120, when an open end of a bag is reinserted between upper exit guide 264 and lower exit guide 82, or when an open end of a bag is reinserted for sealing and foot switch 520 is pressed.

When high level seal routine 1300 is called, material thickness as received from pushbuttons 60 (FIG. 1) or from control 1005 (FIG. 10) may be used to select particular values for the seal parameters described above. Exemplary values for the seal parameters are shown in Table 1.

TABLE 1

| | MINSEAL | MINHEAT | MAXSEAL | MAXHEAT | FBMINHEAT | FBMAXHEAT |
|---|---|---|---|---|---|---|
| | TEMP | TIME | TEMP | TIME | TIME | TIME |
| MILS | (deg C.) | (mS) | (deg C.) | (mS) | (mS) | (mS) |
| 1 | 23 | 220 | 52 | 205 | 325 | 225 |
| 2 | 23 | 225 | 52 | 210 | 325 | 225 |
| 3 | 26 | 287 | 59 | 230 | 363 | 250 |
| 4 | 29 | 350 | 67 | 250 | 400 | 275 |
| 5 | 32 | 375 | 67 | 280 | 435 | 325 |
| 6 | 35 | 400 | 67 | 310 | 470 | 375 |
| 7 | 38 | 435 | 67 | 327 | 500 | 335 |
| 8 | 41 | 470 | 70 | 345 | 535 | 350 |
| 9 | 44 | 505 | 70 | 362 | 540 | 367 |
| 10 | 47 | 540 | 70 | 380 | 545 | 385 |

In step 1315, if the active heater bar temperature is less than the PREHEAT_TEMP, high level seal routine 1300 proceeds to step 1320, otherwise high level seal routine 1300 proceeds to step 1340. In step 1320, variables, for example, FirstBagFlag and FirstBagCount may be initialized as True and 0, respectively, and in step 1325 the heater pulse routine 1500, described in detail below, is called to preheat the active heater bar 374, 450. When the heater pulse routine 1500 returns, a delay_timer is set to the PRHEAT_COOL_DELAY constant and begins counting down, as shown in step 1330 to allow the active heater bar 374, 450 to cool for a period of time. In step 1335, the delay timer is tested to determine if it has reached 0, and if so, the cycle seal bar routine 1400 is called in step 1345. When the cycle seal bar routine 1400 returns the high level seal routine 1300 ends, as shown in step 1350. Returning to step 1315, if the active heater bar temperature is not less than the PREHEAT_TEMP, high level seal routine 1300 proceeds to step 1340 where FirstBagFlag and FirstBagCount may be initialized as False and 0, respectively. The high level seal routine 1300 then proceeds to steps 1345 and 1350 as described above.

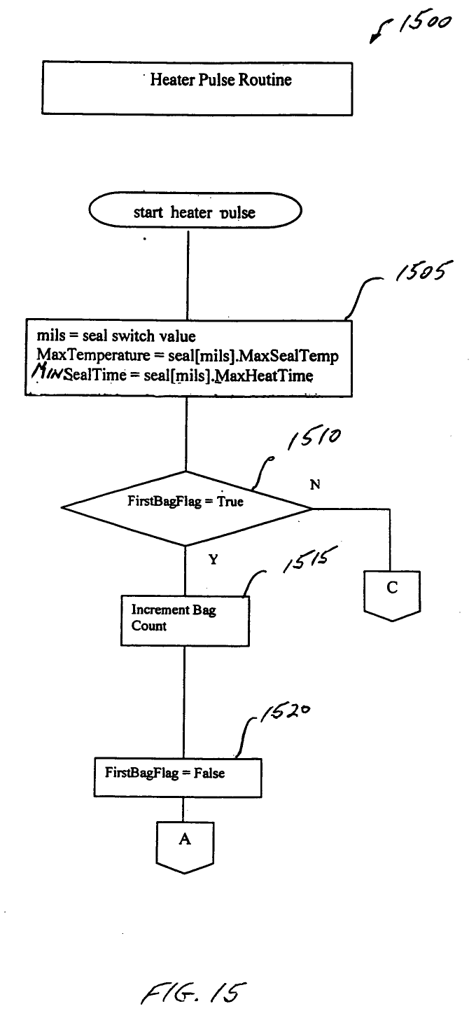

The cycle seal bar routine 1400 will now be described with reference to FIG. 14. Upon initiation, cycle seal bar routine 1400 operates to cause heater seal bar 370 (FIG. 5) to press heat sealable material 36 against active heater bar 374, 450, as shown in step 1405. In step 1410 the heater pulse routine 1500 is called to activate the active heater bar 374, 450 to seal material 36. When the heater pulse routine 1500 returns, a delay_timer is set to the SEAL_DWELL_DELAY constant and begins counting down, as shown in step 1415. In step 1420, the delay timer is tested to determine if it has reached 0, and if so, the cycle seal bar routine 1400 operates to cause heater seal bar 370 (FIG. 5) to separate from heat sealable material 36 and active heater bar 374, 450 in step 1425. The cycle seal bar routine 1400 ends at step 1430.

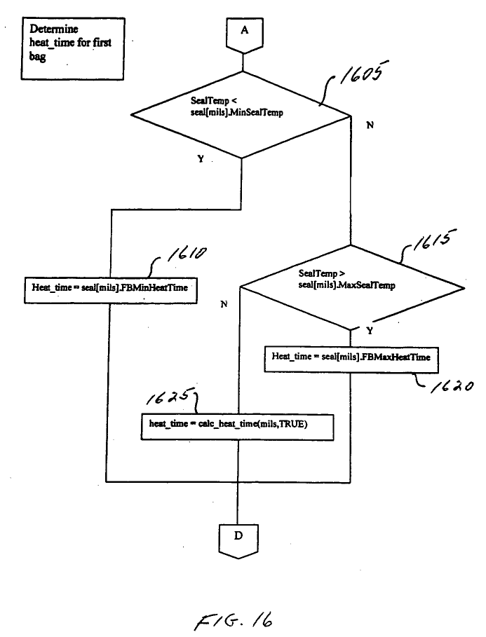

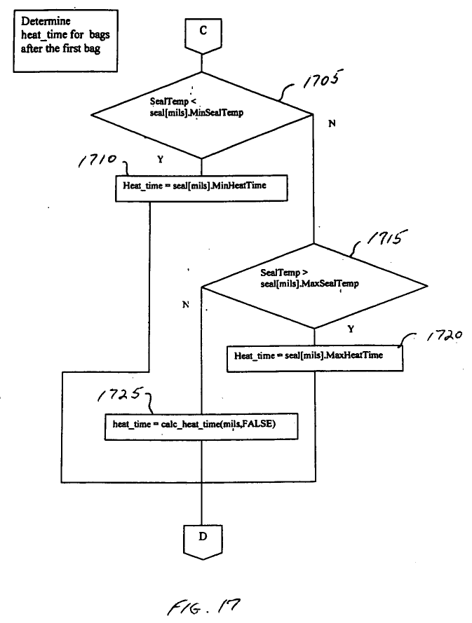

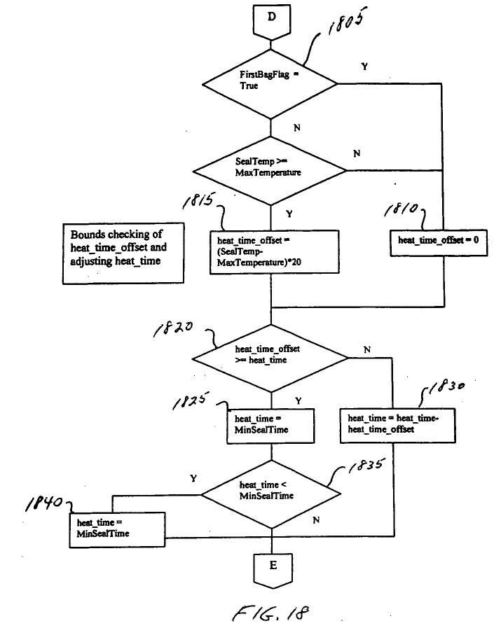

The heater pulse routine 1500 will now be described with reference to FIGS. 15-19. As shown in step 1505, the heater pulse routine 1500 utilizes the material thickness as received from pushbuttons 60 (FIG. 1) or from control 1005 (FIG. 10) to select values for a MaxTemperature (MaxSealTemp) and a MinSealTime (MaxHeatTime) from the seal parameters shown in Table 1. In step 1510 the FirstBagFlag is examined and if True, the heater pulse routine 1500 increments the bag count (step 1515) sets the FirstBagFlag to False and proceeds to determine a heat_time for the first bag as shown in FIG. 16. If in step 1510 the FirstBagFlag is False, the heater pulse routine 1500 proceeds to determine a heat_time for bags after the first bag as shown in FIG. 17.

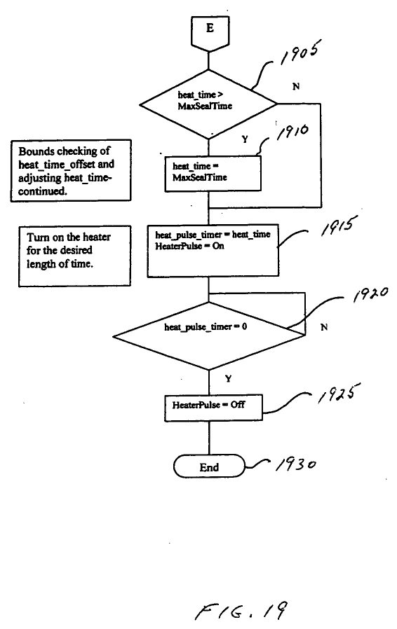

Turning to FIG. 16, the temperature of the active heater bar 374, 450 is measured and if it is less than the MinSealTemp for the particular material thickness as determined from Table 1, the heat_time is set to the FBMinHeatTime value for the particular material thickness found in Table 1, as shown in step 1610. If the temperature of the active heater bar 374, 450 is greater than the MinSealTemp for the particular material thickness as determined from Table 1 (Step 1615), the heat_time is set to the FBMaxHeatTime value for the particular material thickness, as shown in step 1620. Otherwise the subroutine for calculating heat_time 2000 (FIG. 20) is called, as shown in step 1625. Once a heat_time for the first bag has been determined, the heater pulse routine 1500 performs bounds checking as shown in FIG. 18.

Returning to FIG. 15, as mentioned above, if in step 1510 the FirstBagFlag is False, the heater pulse routine 1500 proceeds to determine a heat_time for bags after the first bag as shown in FIG. 17.

In FIG. 17, at step 1705 the temperature of the active heater bar 374, 450 is measured and if it is less than the MinSealTemp for the particular material thickness as determined from Table 1, the heat_time is set to the MinHeatTime value for the particular material thickness found in Table 1 (Step 1710). If the temperature of the active heater bar 374, 450 is greater than the MinSealTemp for the particular material thickness as determined from Table 1 (Step 1715), the heat_time is set to the MaxHeatTime value for the particular material thickness, as shown in step 1720. Otherwise the subroutine for calculating heat_time 2000 (FIG. 20) is called, as shown in step 1725. Once a heat_time for bags after the first bag has been determined, the heater pulse routine 1500 performs bounds checking as shown in FIG. 18.

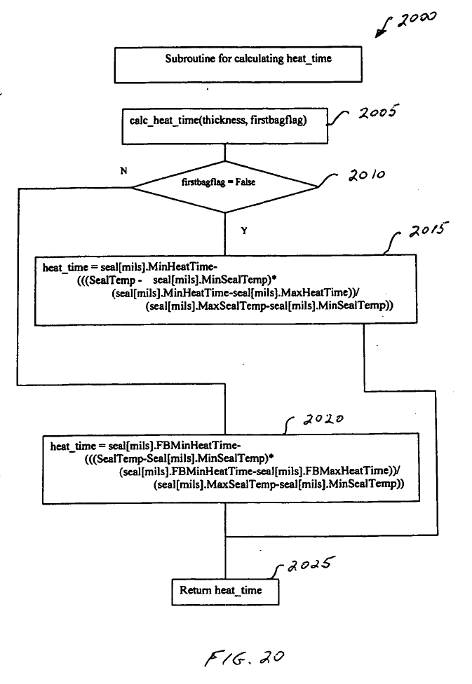

In step 1805 of FIG. 18, if the FirstBagFlag is True, a heat_time_offset factor is set to 0 (step 1810). Otherwise, in step 1815, if the temperature of the active heater bar 374, 450 is greater than or equal to the MaxTemperature determined from step 1505, the heat_time_offset factor is set to a value, in this example, based on the active heater bar temperature and the MaxTemperature. If the temperature of the: active heater bar 374, 450 is not greater than or equal to the MaxTemperature determined from step 1505, the heat_time_offset factor is set 0 (step 1810). Once determined, the heat_time_offset is compared to the heat_time as shown in step 1820. If the heat_time_offset is not greater than or equal to the heat_time, in step 1830 the heat_time is set to a value determined from the heat_time and the heat_time_offset and the heater pulse routine 1500 proceeds to further bounds checking as shown in FIG. 19. However, if in step 1820 the heat_time_offset is greater than or equal to the heat_time, in step 1825 the heat_time is set to the MinSealTime determined from step 1505. In step 1835 if the heat_time is greater than the MinSealTime determined from step 1505, the heat_time is set to the MinSealTime (step 1840). Otherwise the heater pulse routine 1500 proceeds to further bounds checking as shown in FIG. 19.

In step 1905 of FIG. 19, if the heat_time is greater than the MaxSealTime (established as noted further below), the heat_time is set to the MaxSealTime and the heater pulse routine 1500 proceeds to step 1915. Otherwise, the heater pulse routine 1500 proceeds to step 1915 with the current value of the heat_time. In step 1915, a heat_pulse_timer is set to the heat_time value, the heat pulse timer begins counting down, and a HeaterPulse signal is turned on. In step 1920, when the value of the heat_pulse timer is equal to zero, HeaterPulse signal is turned off (step 1925) and the heater pulse routine 1500 ends (step 1930).

As mentioned above, certain steps, for example 1625 and 1725, call the subroutine for calculating heat_time 2000.

The MaxSealTime may be established as a predetermined not to exceed time in which the heat pulse is to be applied. Accordingly, the MaxSealTime may be set as a constant time value, or possibly a variable time value. For instance, the MaxSealTime may be established to include a number of wire factors such as desired heat time duration to prevent degradation of the heat wire.

A flow diagram for this subroutine is shown in FIG. 20. As shown in step 2005, calls for this routine generally include the values of the heat sealable material thickness and the FirstBagFlag. If the FirstBagFlag is False (step 2010) the heat_time is calculated, for example, using the equation of step 2015 which includes values from Table 1 related to sealing bags other than the first bag, for example, MinHeatTime and MaxHeatTime. If the FirstBagFlag is not False in step 2010, the heat_time is calculated, for example, using the equation of step 2020 which includes values from Table 1 related to sealing the first bag, for example, FBMinHeatTime and FBMaxHeatTime. After calculation, the heat_time is returned to the calling routine, as shown in step 2025.

Thus, the exemplary embodiments provide an apparatus and method for automatically controlling sealing operations of machine 20A while accounting for various factors that may influence the sealing operation, including material thickness, the temperature of heater bars 374, 450, and the number of seals that have been made. The exemplary embodiments include one or more heater bar algorithms that may automatically determine a heating time based on one or more factors, for example, a present heater bar temperature, a minimum heating time based on the present heater bar temperature, a heating time for a first group of sealing operations, and a heating time for a subsequent group of sealing operations. The heater bar algorithms may also include bounds checking and adjustments to yield a finally determined heating time which may then be used to control the application of power to heater bars 374, 450.

In the embodiments of the exemplary embodiments described above, it will be recognized that individual elements and/or features thereof are not necessarily limited to a particular embodiment but, where applicable, are interchangeable and can be used in any selected embodiment even though such may not be specifically shown,

Terms such as “upper”, “lower”, “inner, “outer”, “inwardly”, “outwardly”, and the like, when used herein, refer to the positions of the respective elements shown on the accompanying drawing figures and the exemplary embodiments are not necessarily limited to such positions.

It will thus be seen that the objects set forth above, among those elucidated in, or made apparent from, the preceding description, are efficiently attained and, since certain changes may be made in the above construction without departing from the scope of the exemplary embodiments, it is intended that all matter contained in the above description or shown on the accompanying drawing figures shall be interpreted as illustrative only and not in a limiting sense,

It is also to be understood that the following claims are intended to cover all of the generic and specific features of the exemplary embodiments herein described and all statements of the scope of the exemplary embodiments which, as a matter of language, might be said to fall therebetween.

It should be understood that the foregoing description is only illustrative of the exemplary embodiments. Various alternatives and modifications can be devised by those skilled in the art without departing from the exemplary embodiments. Accordingly, the exemplary embodiments described herein are intended to embrace all such alternatives, modifications and variances which fall within the scope of the appended claims.

What is claimed is:

1. A method for sealing a heat sealable material comprising:
dispensing a desired length of the heat sealable material;
automatically selecting a heating time based on one or more sealing parameters selected from the group of a minimum sealing temperature, a minimum heating time, a maximum sealing temperature, and a maximum heating time; and
applying heat to a portion of the heat sealable material according to a sealing routine that utilizes the automatically selected heating time.

2. The method of claim 1, further comprising determining values of the sealing parameters based on a thickness of the heat sealable material.

3. The method of claim 1, further comprising determining values for the minimum heating time and maximum heating time parameters based on whether a first sealing operation of a batch is being performed.

4. The method of claim 1, further comprising comparing the automatically selected heating time to a minimum sealing time and a maximum sealing time determined by a thickness of the heat sealable material.

5. The method of claim 1, wherein the sealing routine comprises a preheating procedure including:
preheating a device for applying heat to a portion of the heat sealable material for a first time period; and
allowing the device to cool for a second time period.

6. The method of claim 5, wherein the first time period is determined from an initial temperature of the device and one or more of the sealing parameters.

7. The method of claim 1, wherein the sealing routine comprises:
applying a heating device to the heat sealable material;
applying power to the heating device for the automatically selected heating time;
removing power from the heating device and allowing the heating device to remain applied to the heat sealable material for a third time period; and
removing the heating device from the heat sealable material.

8. A heat sealing machine comprising:
a mechanism for dispensing a desired length of a heat sealable material;
a processor operable to automatically select a heating time based on one or more sealing parameters selected from the group of a minimum sealing temperature, a minimum heating time, a maximum sealing temperature, and a maximum heating time; and
a heating device for applying heat to a portion of the heat sealable material according to a processor controlled sealing routine that utilizes the automatically selected heating time.

9. The machine of claim 8, wherein the processor is operable to determine values for the minimum heating time and maximum heating time parameters based on whether a first sealing operation of a batch is being performed.

10. The machine of claim 8, further comprising a control for selecting a thickness of the heat sealable material, wherein the processor is operable to determine values of the sealing parameters based on the thickness of the heat sealable material.

11. The machine of claim 10, wherein the processor is operable to compare the automatically selected heating time to a minimum sealing time and a maximum sealing time determined by the thickness of the heat sealable material.

12. The machine of claim 8, wherein during the processor controlled sealing routine, the processor is operable to preheat the heating device for a fourth time period, and is operable to allow the heating device to cool for a fifth time period.

13. The machine of claim 12, wherein the fourth time period is determined from an initial temperature of the heating device and one or more of the sealing parameters.

14. The machine of claim 8, further comprising a mechanism for applying and removing the heating device from the heat sealable material, wherein during the processor controlled sealing routine, the processor is operable to:
cause the mechanism to apply the heating device to the heat sealable material;
apply power to the heating device for the automatically selected heating time;
remove power from the heating device while allowing the heating device to remain applied to the heat sealable material for a third time period; and
cause the mechanism to remove the heating device from the heat sealable material.

15. A computer program product comprising:
a computer useable medium having computer readable code means embodied therein for causing a computer to execute a method for sealing a heat sealable material, the computer readable code means in the computer program product including:
computer readable program code means for causing a computer to dispense a desired length of the heat sealable material;
computer readable program code means for causing a computer to automatically select a heating time based on one or more sealing parameters selected from the group of a minimum sealing temperature, a minimum heating time, a maximum sealing temperature, and a maximum heating time; and
computer readable program code means for causing a computer to apply heat to a portion of the heat sealable material according to a sealing routine that utilizes the automatically selected heating time.

16. The computer program product of claim 15, further comprising computer readable program code means for causing a computer to determine values of the sealing parameters based on a thickness of the heat sealable material.

17. The computer program product of claim 15, further comprising computer readable program code means for causing a computer to determine values for the minimum heating time and maximum heating time parameters based on whether a first sealing operation of a batch is being performed.

18. The computer program product of claim 15, further comprising computer readable program code means for causing a computer to compare the automatically selected heating time to a minimum sealing time and a maximum sealing time determined by a thickness of the heat sealable material.

19. The computer program product of claim 15, wherein the sealing routine comprises a preheating procedure including:
computer readable program code means for causing a computer to preheat a device for applying heat to a portion of the heat sealable material for a first time period; and
computer readable program code means for causing a computer to allow the device to cool for a second time period.

20. The computer program product of claim 19, wherein the first time period is determined from an initial temperature of the device and one or more of the sealing parameters.

21. The computer program product of claim 15, wherein the sealing routine comprises:
computer readable program code means for causing a computer to apply a heating device to the heat sealable material;
computer readable program code means for causing a computer to apply power to the heating device for the automatically selected heating time;
computer readable program code means for causing a computer to remove power from the heating device and allowing the heating device to remain applied to the heat sealable material for a third time period; and
computer readable program code means for causing a computer to remove the heating device from the heat sealable material.

22. A bag dispenser comprising:
a sealing device
a controller programmed to control the sealing device; and
a program for use by the controller for automatically selecting a sealing time for the sealing device, wherein the sealing time is selected according to one or more of a bag count or a parameter of the sealing device.

23. The bag dispenser of claim 22, wherein a bag count of 0 results in a first sealing time.

24. The bag dispenser of claim 22, wherein a bag count of other than 0 results in a second sealing time.

25. The bag dispenser of claim 22, wherein the program is operable to compare the automatically selected sealing time to a minimum sealing time and a maximum sealing time determined by a thickness of the dispensed bag.

26. The bag dispenser of claim 22, wherein the parameter of the sealing device includes one or more parameters selected from the group of a minimum sealing temperature, a minimum heating time, a maximum sealing temperature, and a maximum heating time.

27. The bag dispenser of claim 26, wherein values for the minimum heating time and maximum heating time parameters are based on whether a first sealing operation of a batch is being performed.

28. A bag dispenser comprising:
a bag selector for selecting one of a bag width or a bag thickness for effecting an automatic bag selection; and
a controller responsive to an output of the selector for programmatically determining a seal time for the automatically selected bags.
